(19) United States
(12) Patent Application Publication
(10) Pub. No.: US 2026/0104035 A1
(43) Pub. Date: Apr. 16, 2026

(54) METHOD OF DETERMINING A TEMPERATURE OF A HEATING ELEMENT OF A WIND TURBINE BLADE

(71) Applicant: LM Wind Power A/S, Kolding (DK)

(72) Inventors: Parag Rameshchandra Dharmadhikari, Salzbergen (DE); Yarú Méndez, Kolding (DK); Lars Bo Hansen, Kolding (DK); Isaac Alejandro Martinez Tovar, Kolding (DK)

(21) Appl. No.: 19/115,942

(22) PCT Filed: Sep. 26, 2023
(86) PCT No.: PCT/EP2023/076604

§ 371 Date: Mar. 27, 2025

(30) Foreign Application Priority Data
Sep. 28, 2022 (EP) 22198436.2

(51) Int. Cl. F03D 17/00; F03D 80/40; G01K 15/00

(52) U.S. Cl. CPC F03D 17/018; F03D 80/401; G01K 15/007; F05B 2260/20; G01K 2217/00

(57) ABSTRACT

A method of determining a temperature of a heating element (210) of a wind turbine blade (200) includes heating the heating element by providing a heating current in the heating element. The method includes measuring a first value (I₁) of the heating current at a first time. The method includes determining a first temperature (T₁) of the heating element using the measured first value of the heating current and a known functional dependency (410) between the heating current in the heating element and the temperature of the heating element.

### FIELD

The present subject matter relates generally to heating elements provided in one or more rotor blades of a wind turbine, such as for the purpose of de-icing the blades. More specifically, embodiments described herein relate to methods for determining the temperature of a heating element of a wind turbine blade during operation of the heating element.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and a rotor with one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

During operation of a wind turbine, the rotor blades may be subjected to very cold temperatures. Accordingly, ice may form on the blades, which may decrease the performance of the wind turbine or cause a failure in some of the wind turbine components. For removing the ice on the wind turbine blade, or for preventing the formation of ice, a wind turbine blade may include one or more heating elements.

In order to provide an optimal operation of such a heating element, it may be beneficial to monitor the temperature of the heating element as the heating element is heated. The determined temperature may be used to prevent, for example, that the heating element becomes too hot, since overly high temperatures may, for example, decrease the lifetime of the heating element.

For determining the temperature of a heating element, temperature sensors may be installed in the wind turbine blade. Some sensors may provide an accurate determination of the temperature. Yet, such sensors may have the disadvantage that they are expensive and that they further complicate the design of the wind turbine blade.

Accordingly, there is a need for improved methods for determining the temperature of a heating element of a wind turbine blade.

### BRIEF DESCRIPTION

Aspects and advantages of the invention will be set forth in part in the following description, or may be obvious from the description, or may be learned through practice of the invention.

According to an embodiment, a method of determining a temperature of a heating element of a wind turbine blade is provided. The method includes heating the heating element by providing a heating current in the heating element. The method includes measuring a first value of the heating current at a first time. The method includes determining a first temperature of the heating element using the measured first value of the heating current and a known functional dependency between the heating current in the heating element and the temperature of the heating element.

According to a further embodiment, a system for determining a temperature of a heating element of a wind turbine blade is provided. The system includes a current sensor for measuring, at a first time, a first value of a heating current provided in the heating element. The system includes a controller configured for determining a first temperature of the heating element using the measured first value of the heating current and a known functional dependency between the heating current in the heating element and the temperature of the heating element.

According to a further embodiment, a wind turbine is provided. The wind turbine includes a rotor having a wind turbine blade including a heating element. The wind turbine includes a power supply for supplying a heating current to the heating element. The wind turbine includes a system for determining a temperature of the heating element according to embodiments described herein.

According to a further embodiment, a computer program product or a non-transitory computer-readable storage medium is provided. The computer program product or non-transitory computer-readable storage medium includes instructions which, when executed by one or more processors of a system, cause the system to determine a first temperature of a heating element using a measured first value of a heating current provided in the heating element and a known functional dependency between the heating current in the heating element and the temperature of the heating element. The computer program product or non-transitory computer-readable storage medium may be configured for carrying out any operation(s) performed by the controller for determining the temperature of the heating element according to the method described herein.

According to a further embodiment, a method for determining a performance degradation characteristic of a heating element of a wind turbine blade is provided. The method includes applying a voltage to the heating element to provide a heating current in the heating element for heating the heating element, wherein the heating current is provided during a heating cycle of the heating element. The method includes performing a cold measurement of the heating current at an initial phase of the heating cycle before the heating current causes the heating element to substantially heat up, wherein the cold measurement yields a measured value of the heating current. The method includes determining a performance degradation characteristic of the heating element using the measured value of the heating current and the applied voltage.

These and other features, aspects and advantages of the present invention will be further supported and described with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates an example of a wind turbine;

FIGS. 2-3 show a wind turbine blade including a heating element;

FIG. 4 illustrates a functional dependency between a heating current in a heating element and the temperature of the heating element;

FIG. 5 shows a test heating element that may be used in a testing phase as described herein;

FIG. 6 illustrates the collection of measured data in a testing phase for determining a functional dependency between a heating current in a heating element and the temperature of the heating element; and

FIG. 7 shows a wind turbine including a current sensor for measuring the heating current in a heating element.

Single features depicted in the figures are shown relatively with regards to each other and therefore are not necessarily to scale. Similar or same elements in the figures, even if displayed in different embodiments, are represented with the same reference numbers.

### DETAILED DESCRIPTION OF THE INVENTION

Reference now will be made in detail to embodiments of the invention, one or more examples of which are illustrated in the drawings. Each example is provided by way of explanation of the invention, which shall not limit the invention. In fact, it will be apparent to those skilled in the art that various modifications and variations can be made in the present invention without departing from the scope or spirit of the invention, for instance, features illustrated or described as part of one embodiment can be used with another embodiment to yield a still further embodiment. Thus, it is intended that the present invention covers such modifications and variations as come within the scope of the appended claims and their equivalents.

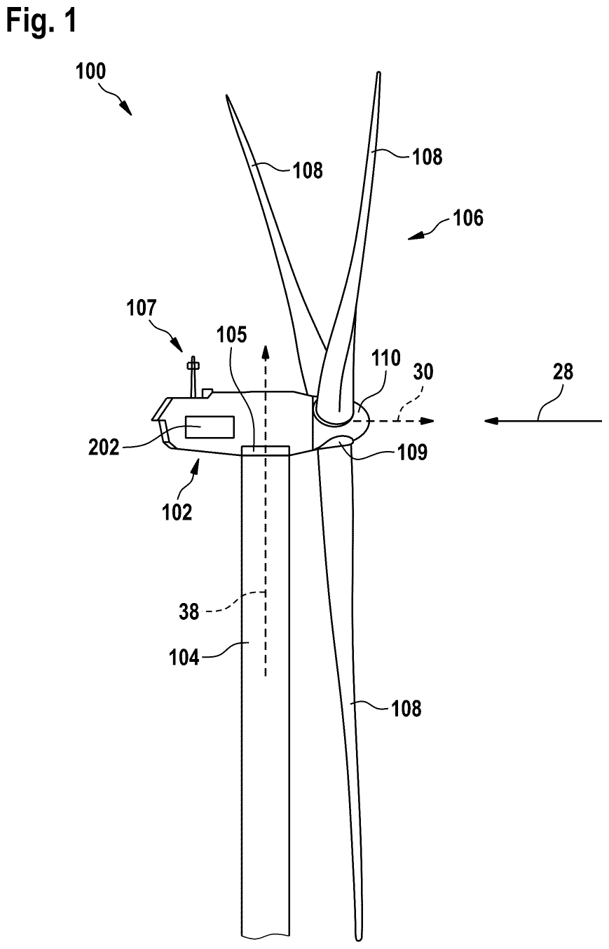

FIG. 1 is a perspective view of a portion of an exemplary wind turbine 100. In the exemplary embodiment, the wind turbine 100 is a horizontal-axis wind turbine. Alternatively, the wind turbine 100 may be a vertical-axis wind turbine. Wind turbine 100 may include a nacelle 102 that may house a generator (not shown in FIG. 1). Nacelle 102 may be mounted on a tower 104 of the wind turbine 100 (a portion of tower 104 being shown in FIG. 1). Tower 104 may have any suitable height that facilitates operation of wind turbine 100 as described herein. Wind turbine 100 may include a rotor 106. The rotor 106 may include three wind turbine blades 108 that may be attached to a hub 110. The hub 110 may be a rotating hub. Alternatively, wind turbine 100 includes any number of blades 108 that facilitates operation of wind turbine 100 as described herein. In the exemplary embodiment, wind turbine 100 includes a gearbox (not shown in FIG. 1) operatively coupled to rotor 106 and a generator (not shown in FIG. 1).

The rotor blades 108 may be spaced about the hub 110 to facilitate rotating the rotor 106 to enable kinetic energy to be transferred from the wind into usable mechanical energy, and subsequently, electrical energy.

In one embodiment, the rotor blades 108 may have a length ranging from about 15 meters (m) to about 91 m. Alternatively, rotor blades 108 may have any suitable length that enables the wind turbine 100 to function as described herein. For example, other non-limiting examples of blade lengths include 20 m or less, 37 m, 48.7 m, 50.2 m, 52.2 m or a length that is greater than 91 m. As wind strikes the rotor blades 108 from a wind direction 28, the rotor 106 is rotated about an axis of rotation 30. As the rotor blades 108 are rotated and subjected to centrifugal forces, the rotor blades 108 are also subjected to various forces and moments. As such, the rotor blades 108 may deflect and/or rotate from a neutral, or non-deflected, position to a deflected position.

Moreover, a pitch angle of the rotor blades 108, i.e., an angle that determines a perspective of the rotor blades 108 with respect to the wind direction, may be changed by a pitch system 109 to control the load and power generated by the wind turbine 100 by adjusting an angular position of at least one rotor blade 108 relative to wind vectors. During operation of the wind turbine 100, the pitch system 109 may change a pitch angle of the rotor blades 108 such that the rotor blades 108 are moved to a feathered position, such that the perspective of at least one rotor blade 108 relative to wind vectors provides a minimal surface area of the rotor blade 108 to be oriented towards the wind vectors, which facilitates reducing a rotational speed and/or facilitates a stall of the rotor 106.

A blade pitch of each rotor blade 108 may be controlled individually by a wind turbine controller 202 or by a pitch control system. Alternatively, the blade pitch for all rotor blades 108 may be controlled simultaneously by said control systems.

Further, in the exemplary embodiment, as the wind direction 28 changes, a yaw direction of the nacelle 102 may be rotated, by a yaw system 105, about a yaw axis 38 to position the rotor 106 with respect to wind direction 28. The yaw system 105 may include a yaw drive mechanism provided by nacelle 102. Further, yaw system 105 may also be controlled by wind turbine controller 202.

For positioning nacelle 102 appropriately with respect to the wind direction 28 as well as detecting a wind speed, the nacelle 102 may also include at least one meteorological mast 107 that may include a wind vane and anemometer. The mast 107 may provide information to the wind turbine controller 202 regarding ambient conditions. This may include wind direction and/or wind speed as well as ambient temperature, ambient moisture, precipitation type and/or amount (if any).

In the exemplary embodiment, the wind turbine controller 202 is shown as being centralized within the nacelle 102, however, the wind turbine controller may also be a distributed system throughout the wind turbine 100, on a support system (not shown in FIG. 1), within a wind farm, and/or at a remote-control center. The wind turbine controller 202 includes a processor and may be configured to perform the methods and/or steps described herein.

During operation of a wind turbine, the wind turbine, and in particular the rotor blades, may be subject to harsh weather conditions, such as cold temperatures. For example, ice may accumulate on the wind turbine blades. The formation of ice on the rotor blades can be disadvantageous for the operation of the wind turbine. For example, due to the ice, the power production of the wind turbine may decrease.

In one or more rotor blades of a wind turbine, a heating element, or a plurality of heating elements, may be provided. A heating element may be used for heating a wind turbine blade, or a portion thereof, for example for de-icing the wind turbine blade. De-icing may include the removal of ice formed on the wind turbine blade and the prevention of a formation of ice on the wind-turbine blade. The heating element may be an electrically conductive element that is heated by passing an electrical current, or heating current, through at least a portion of the heating element.

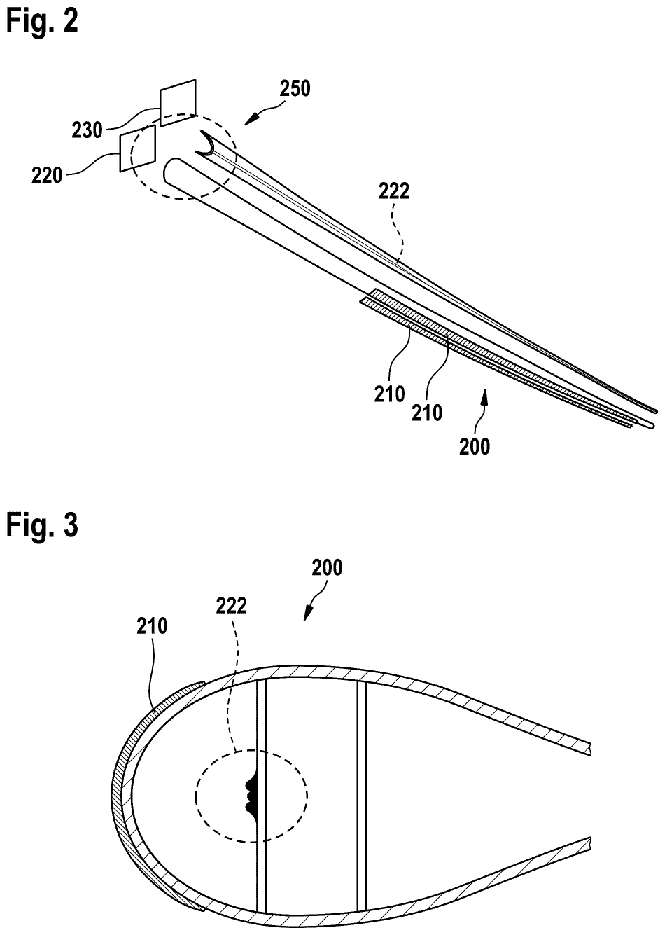

FIGS. 2-3 show an example of a wind turbine blade 200, i.e. a rotor blade, including a heating element 210. The wind turbine blade 200 may be a rotor blade 108 as described herein. In the example shown, two heating elements 210 are provided, but the disclosure is not limited thereto. A wind turbine blade 200 can include a single heating element 210, or more than two heating elements 210. The heating element(s) may be, at least partially, embedded in an interior portion of the wind turbine blade 200. In some embodiments, a heating element 210 may be a thin, sheet-like piece of material, such as a textile material. A heating element 210 may be a heating mat. The heating element 210 may have an elongated shape that may, for example, extend over a portion of the wind turbine blade 200 along a length direction of the wind turbine blade 200. The heating element 210, such as a heating mat, may include, or be formed from, carbon. For example, the heating element may include or be a carbon fabric layer.

The wind turbine may include a power supply 220 for supplying an electrical current to a heating element 210. One power supply 220 may provide power to multiple heating elements 210 of a same wind turbine blade. Alternatively, several power supplies 220 may be provided, and each heating element 210 may receive a current from a respective power supply 220. The wind turbine blade 200 may include one or more power cables 222 connecting a heating element 210 with a power supply 220.

A power supply 220 for supplying an electrical current to a heating element 210 may, for example, be disposed in or near the hub of the wind turbine. The power supply 220 may disposed in the hub near a proximal end 250 of the wind turbine blade 200. The disclosure is not limited thereto, and the power supply 220 may be provided at other locations suitable for providing power to the heating element 210.

In operation, a power supply 220 may apply a voltage to a heating element 210 to provide an electrical current, or heating current, in the heating element 210 for heating the heating element 210, for example for de-icing at least a portion of the wind turbine blade 200. The heating element 210 may be a resistive element that heats up due to the heating current in the heating element 210.

The heating of a heating element 210 may be a controlled heating that is controlled by a controller 230 of the wind turbine. Under the control of the controller 230, the magnitude of the heating current in the heating element, and accordingly the temperature of the heating element 210, may be controlled. The controller 230 may, for example, be disposed in the hub of the wind turbine. The disclosure is not limited thereto, and the controller 230 may be disposed in other locations. The controller 230 may be part of a general wind turbine controller, or may be a separate controller. The controller 230 may be the wind turbine controller 202 shown in FIG. 1.

It may be beneficial to determine the temperature of a heating element 210 during operation, i.e. the temperature of the heating element caused by the heating current in the heating element. For example, operation of the heating element 210 may be non-optimal if the temperature of the heating element 210 exceeds a certain upper limit. If the heating element operates at temperatures that are too high, the lifetime and/or performance of the heating element 210 may decrease. In some embodiments, a control of the temperature of the heating element 210 can be facilitated by applying a known voltage to the heating element, e.g. by a power supply 220 as described herein. Yet, even in such case the heating element 210 may be subject to temperature variations that are a priori unknown, and an accurate determination of the temperature may be beneficial.

Embodiments described herein provide a method for determining the temperature of a heating element 210, such as a carbon heating mat, during operation of the heating element. Advantageously, embodiments described herein do not require separate temperature sensors to be installed in the wind turbine blade for determining the temperature of the heating element 210. Instead, the heating element 210 itself is used as a sensor to determine the temperature thereof. According to embodiments described herein, the temperature of the heating element 210 is determined based on a functional dependency between the magnitude of the heating current in the heating element 210 and the temperature of the heating element 210.

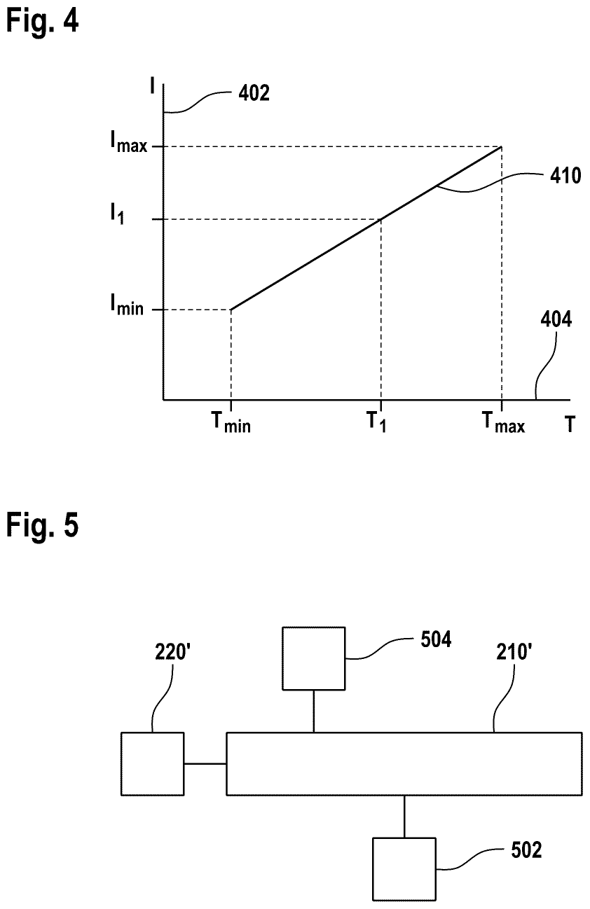

FIG. 4 shows an example of a functional dependency 410 between the heating current provided in a heating element 210 and the temperature of the heating element 210. The temperature of the heating element 210 may, for example, be an average temperature of the heating element 210 with respect to a plurality of locations on the heating element 210. The functional dependency 410 may relate a magnitude of the heating current provided in the heating element 210 to a corresponding temperature of the heating element 210. The functional dependency may include a, possibly continuous, set of points, each point having the form (T, I), where T is the temperature of the heating element and I is the corresponding heating current in the heating element 210.

In the example shown in FIG. 4, the functional dependency 410 is a linear dependency. The heating current, shown on the vertical axis 402, is a linear function of the temperature, shown in the horizontal axis 404, of the heating element 210. For example, the functional dependency 410 between the heating current I and the temperature T may have the form I=Iₘᵢₙ+α(T−Tₘᵢₙ), where Iₘᵢₙ and Tₘᵢₙ are constants denoting a minimum heating current and corresponding a minimum temperature, respectively, and α is a coefficient represents the slope of the linear curve shown in FIG. 4. The disclosure is not limited thereto. The functional dependency 410 may be a different kind of dependency, such a dependency that is only approximately linear, or has at least one or more non-linear portions, and the like.

In the example shown in FIG. 4, the functional dependency 410 is a continuous function providing, for each current between a minimal current Iₘᵢₙ and a maximal current Iₘₐₓ, a corresponding temperature value—or equivalently, providing, for each temperature between a minimal temperature Tₘᵢₙ and a maximal temperature Tₘₐₓ, a corresponding magnitude of the heating current. The disclosure is not limited thereto. The functional dependency 410 may, for example, be a discrete function. For example, the functional dependency 410 may consist of a finite set of points (T₁, I₁) . . . , (T_{N}, I_{N}) that each provide a temperature and a corresponding heating current. As a further example, the functional dependency 410 may include a combination of continuous and discrete portions.

According to embodiments described herein, the functional dependency 410 is known. The functional dependency 410 may be determined beforehand in a testing phase, where information regarding the relation between the heating current and the temperature of the heating element 210 is collected by performing measurements. This will be described in more detail below.

During operation of the heating element 210, the magnitude (or value) of the heating current in the heating element 210 can be measured. Using the functional dependency 410, the temperature of the heating element 210 corresponding to said magnitude can be determined. For example, with respect to the linear functional dependency 410 shown in FIG. 4, once the magnitude of the heating current, corresponding to a value I₁ on the vertical axis 402, has been measured, a corresponding value T₁ of the temperature on the horizontal axis 404 can be determined.

As described above, embodiments described herein allow determining the temperature of the heating element 210 without installing separate temperature sensors in the wind turbine blade. The heating element 210 itself is used a sensor to determine the temperature of the heating element.

Further, the temperature of the heating element 210 may be determined without measuring or otherwise determining the resistance (or impedance) of the heating element. The information provided by the functional dependency between the heating current and the temperature may suffice to determine the temperature of the heating element. In particular, it may not be necessary to measure the voltage across the heating element 210 for determining the temperature of the heating element 210. Embodiments described herein allow determining the temperature of the heating element 210 based on a measurement of the heating current alone, without requiring a measurement of the voltage or the resistance of the heating element.

In light of the above, according to an embodiment, a method of determining a temperature of a heating element of a wind turbine blade is provided. The method includes heating the heating element by providing a heating current in the heating element. The method includes measuring a first value of the heating current at a first time. The method includes determining a first temperature of the heating element using the measured first value of the heating current and a known functional dependency between the heating current in the heating element and the temperature of the heating element.

According to embodiments described herein, the first temperature of the heating element is determined without determining an electrical resistance or impedance of the heating element.

A heating element, as described herein, of a wind turbine blade may be electrically conductive. The heating element may include carbon or another conductive material. The heating element may be a thin piece of material, such as a composite material, in the form of a sheet. The heating element may be a heating mat of a wind turbine blade, such as a carbon heating mat.

A heating current, as described herein, can be understood as an electrical current that is passed through the heating element to heat the heating element. A function of the heating current is to heat the heating element, for example for de-icing the wind turbine blade of which the heating element forms part. The heating element may be heated due to Ohmic heating by providing the heating current in the heating element. In other words, the heating element may act as an electrical resistance that heats up by passing the heating current through the heating element. The method described herein may include applying a voltage to the heating element to provide the heating current in the heating element.

The first value of the heating current may be measured by a current sensor as described herein.

A heating element as described herein may be configured for de-icing the wind turbine blade (or at least a portion thereof) in which the heating element is installed. The heating current in the heating element may be configured to heat the heating element to a temperature sufficient for de-icing the wind turbine blade. For example, the heating current may heat the heating element to a temperature of 5 degrees (Celsius) or more, particularly 10 degrees or more. The heating current may have a magnitude of 40 A (Ampere) or more, 50 A or more, such as, for example, from 52.5 A to 53.5 A, particularly from 53 A to 53.5 A.

The notion of a functional dependency, or functional relationship, between the heating current provided in the heating element and the temperature of the heating element can be understood as a relation between a magnitude of the heating current flowing through the heating element and the temperature of the heating element corresponding to said magnitude of the heating current. For example, the functional dependency may have the form of a function I(T) where T represents the temperature of the heating element and I represents the corresponding magnitude of the heating current flowing through the heating element at the temperature T. Equivalently, the functional dependency may be a function T(I) representing the temperature T of the heating element as a function of the magnitude of the heating current I passing through the heating element. The disclosure is not limited to the aforementioned examples, and the functional dependency can take other forms.

That the functional dependency is “known” can be understood in the sense that the functional dependency has been determined previously and is available for being consulted, e.g. by a controller or a portion of a controller, and/or by a human operator. For example, the known functional dependency may be stored in a memory, for example a memory of a controller of the wind turbine, or another memory external to the wind turbine, and said memory may be read at the appropriate time when the functional dependency is needed for determining the temperature of the heating element as described herein.

The known functional dependency may be, at least approximately, a linear dependency, or linear relationship, between the heating current and the temperature. For example, the function I(T) described above may be a linear function of the temperature T.

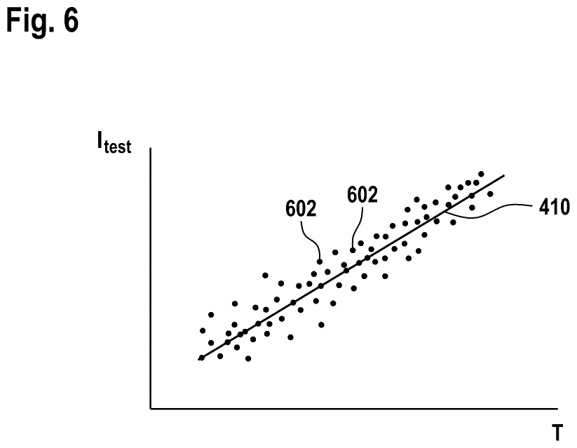

The functional dependency between the heating current and the temperature may be obtained from a testing phase. FIGS. 5-6 illustrate such a testing phase.

FIG. 5 shows a test heating element 210′. The test heating element 210′ may be identical to the heating element 210, i.e. may have the same shape, composition, design, functional properties, and the like. During the testing phase, the test heating element 210′ may be part of a wind turbine blade or may be a separate component that is subjected to the testing phase in a laboratory or other testing area. The test heating element 210′ may be connected to a power supply 220′ for supplying a test heating current to the test heating element 210′ for heating the test heating element 210′. The test heating element 210′ may be connected to at least one current sensor 504 for measuring a magnitude of the test heating current in the test heating element 210′. For example, the at least one current sensor 504 may include a Rogowski coil. The test heating element 210′ may be connected to at least one temperature sensor 502 for measuring a temperature of the test heating element 210′. For example, the temperature sensor 502 may include a micro integrated circuit, such as a negligible thermal mass micro integrated circuit.

A testing phase may include providing a test heating current in the test heating element 210′ using the power supply 220′ at a plurality of different magnitudes of the test heating current and/or at a plurality of external conditions. Each of the different magnitudes of the test heating current may be measured by the at least one current sensor 504, for example at different external conditions. The corresponding temperatures of the test heating element 210′ for each of the different magnitudes of the test heating current may be measured by the at least one temperature sensor 502. FIG. 6 shows an example of experimental data collected in the testing phase. Each data point 602 represents a pair of values (T, I) where I is a magnitude of the test heating current as measured by the at least one current sensor 504 and T is the corresponding temperature of the test heating element 210′ as measured by the at least one temperature sensor 502.

Using the experimental data gathered in the testing phase, a functional dependency between the heating current and the temperature of the (test) heating element can be determined, for example by fitting a suitable function to the collected data points. As illustrated in FIG. 6, a functional dependency 410, e.g. a linear functional dependency, can be fit to the data points. Once the functional dependency 410 has been determined, the functional dependency 410 may be stored and used (and re-used) for determining a temperature of a heating element 210 in the manner described herein.

According to embodiments described herein, a testing phase may include heating a test heating element of, or for, a wind turbine blade by providing a test heating current in the test heating element. The test heating element may be a heating element with similar, or even the same, properties as the heating element described herein. In particular, the test heating element may be a carbon heating mat. The test heating current may be an electrical current configured for heating the heating element, for example for de-icing, like the heating current that is provided in the heating element as described herein.

The testing phase may include measuring a plurality of values of the test heating current and corresponding values of the temperature of the test heating element at different times. For each measured value, or magnitude, of the test heating current, a value of the temperature of the test heating element corresponding to said value of the test heating current may be measured. For example, 10 or more, 50 or more or even 80 or more values of the test heating current and corresponding values of the temperature may be measured. The test heating current may be measured by one or more first sensors, such as one or more current sensors. The one or more first sensors may be connected to the test heating element. The temperature of the test heating element may be measured using one or more second sensors, such as one or more temperature sensors. The one or more second sensors may be connected to the test heating element.

The testing phase may include determining a functional dependency between the test heating current provided in the test heating element and the temperature of the test heating element based on the plurality of measured values of the test heating current and the measured values of the temperature of the test heating element. The functional dependency may be determined by a controller. Determining the functional dependency may include fitting a function or relationship to the plurality of measured values of the test heating current and the corresponding measured values of the temperature of the test heating element. For example, a linear function, or linear relationship may be fitted to the measured data.

Once the functional dependency between the test heating current in the test heating element and the temperature of the test heating element has been determined, said determined functional dependency may then serve as the known functional dependency between the heating current in the heating element and the temperature of the heating element as described herein. That is to say, the determined functional dependency for the test heating element (e.g. test heating element 210′ shown in the figures) may be the known functional dependency that is used for determining the temperature of the heating element (e.g. heating element 210 shown in the figures).

The testing phase may be performed on a wind turbine that is off-line (not in operation) or even on a test heating element that is a separate component not installed in a wind turbine or wind turbine blade.

Returning to FIG. 4, reference is made to the minimum heating current Iₘᵢₙ and the corresponding minimum temperature Tₘᵢₙ. The minimum heating current Iₘᵢₙ is also referred to herein as a cold current value. The cold current value may be an amount of heating current in the heating element 210 before the heating element starts to substantially heat up, for example within the initial 5-10 seconds of a heating cycle, such as within the initial 2 seconds of a heating cycle. The minimum temperature Tₘᵢₙ, or cold temperature, is the temperature of the heating element 210 corresponding to the cold current value. The cold temperature may, for example, be substantially equal to the ambient temperature of the region surrounding the wind turbine blade.

The functional dependency 410 may depend on the cold current value Iₘᵢₙ. For example, as described above, a linear functional dependency 410 may have the form I=Iₘᵢₙ+α(T−Tₘᵢₙ). The value Iₘᵢₙ may be determined offline, for example, as part of a testing phase as described herein, or online, e.g. as part of a method for determining the temperature of the heating element according to embodiments described herein. According to embodiments described herein, after a value I₁ of the heating current in the heating element 210 has been measured, a corresponding value T₁ of the temperature of the heating element 210 may be determined from the functional dependency 410 by inputting the measured value of the heating current, the cold current value Iₘᵢₙ and the minimum temperature current value Tₘᵢₙ in the functional dependency and calculating the temperature T based on said values.

According to embodiments described herein, the first temperature of the heating element may be determined using the measured first value of the heating current, the known functional dependency between the heating current in the heating element and the temperature of the heating element, and a cold current value of the heating current. The cold current value represents a magnitude of the heating current flowing in the heating element at an initial phase (or cold phase) of a heating cycle before the heating current causes the heating element to substantially heat up, for example while the temperature of the heating element is still below 0 degrees (Celsius), particularly below −5 degrees. For example, the cold current value may be a magnitude of the heating current flowing in the heating element within 5 s (seconds) or less, particularly 2 s or less, more particularly 1 s or less, after the heating cycle has started. The cold current value may be a known, previously determined quantity, for example a quantity obtained as part of a testing phase as described herein. Alternatively, the cold current value may be determined as part of the method described herein. For example, the cold current value may be determined in a cold measurement as described herein.

The measured first value of the heating current may be denoted by I1. The cold current value may be denoted by Iₘᵢₙ. In some embodiments, for example embodiments where the heating current I(T) is, at least approximately, a linear function of the temperature T, the temperature of the heating element may be determined using a difference I1−Iₘᵢₙ between the measured first value In and the cold current value Iₘᵢₙ of the heating current. For example, if the functional dependency as described herein has the form I=Iₘᵢₙ+α(T−Tₘᵢₙ), the temperature may be derived as T=(I−Iₘᵢₙ)/α+Tₘᵢₙ, which involves the difference I−Iₘᵢₙ.

The method described herein may include measuring a second value of the heating current at a second time, for example by a current sensor as described herein. In an example, but without limitation, the second time may be before the first time at which the first value of the heating current is measured. The first time and the second time may belong to a same heating period, or same heating cycle, of the heating element. The second time may be an initial time within a heating cycle and the first time may be a later time within the same heating cycle.

The first temperature of the heating element, as described herein, may be determined, for example by a controller as described herein, using the measured first value of the heating current, the measured second value of the heating current, and the known functional dependency between the heating current in the heating element and the temperature of the heating element. The method may include inputting the measured first value and/or the measured second value of the heating current into the known functional dependency, for example using a controller as described herein. The method may include determining, or deriving, the first temperature from the known functional dependency in which said measured first value and/or said measured second value have been inputted. Said first temperature may be determined using a controller as described herein.

The measured first value of the heating current may be denoted by I₁. The measured second value of the heating current may be denoted by I₂. In some embodiments, for example embodiments where the heating current I(T) is, at least approximately, a linear function of the temperature T, the temperature of the heating element may be determined using a difference I₁−I₂ between the measured first value I₁ and the measured second value I₂ of the heating current.

The measurement of the second value of the heating current may be a cold measurement performed at an initial phase (or cold phase) of a heating cycle before the heating current causes the heating element to substantially heat up. In such case, the second value I₂ of the heating current may be the cold current value Iₘᵢₙ as described herein.

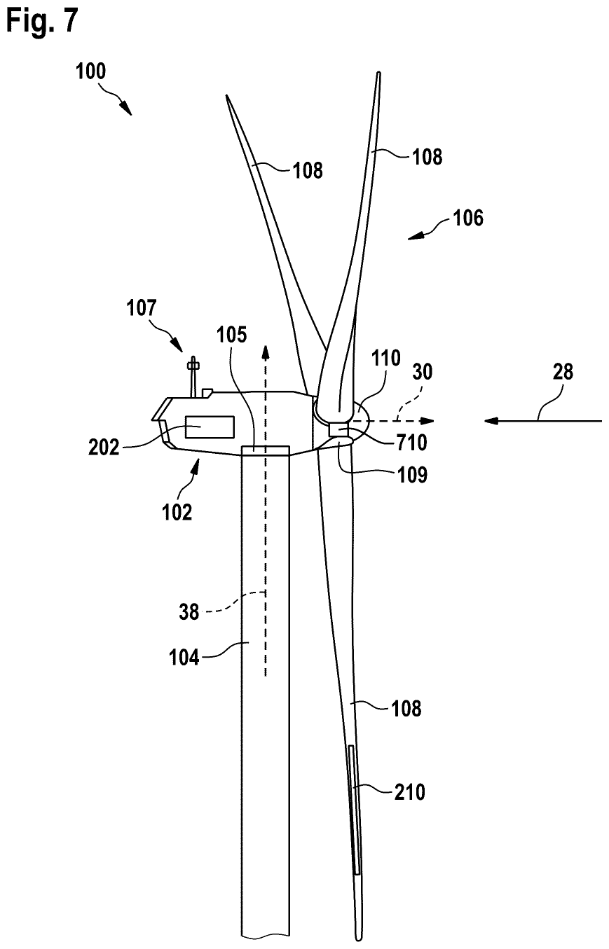

FIG. 7 shows a wind turbine according to embodiments described herein. The wind turbine includes a current sensor 710 for measuring the heating current in the heating element 210. The current sensor 710 may be a current transducer disposed in the hub 110 of the wind turbine.

According to embodiments described herein, the heating element is part of a wind turbine blade of a wind turbine. The wind turbine may have a hub to which the wind turbine blade is attached. The first value of the heating current and/or the second value of the heating current may be measured by a current sensor, which may be disposed in the hub. The current sensor may be a current transducer, which may be disposed in the hub. The disclosure is not limited thereto, and other current sensors can be used for measuring the heating current. The term “current sensor” as used herein refers to any sensor suitable for measuring, either directly or indirectly, an amount of current. For example, a current sensor can be a toroid transducer.

An advantage of using a current transducer is that such current transducer may already be installed for normal operation of the heating element i.e. in the context of the heating function of the heating element, irrespective of whether the temperature of the heating element shall be determined. Using the same current transducer to perform the measurement of the heating current as a part of the method for determing the temperature of the heating element means that no additional current sensors need to be provided.

Embodiments described herein may include determining a performance degradation characteristic, or performance degradation analytic, based on a cold measurement of the heating element 210, as described in the following.

The method as described herein may include applying a voltage to the heating element to provide the heating current in the heating element, wherein the heating current is provided during a heating cycle of the heating element. The method may include performing a cold measurement of the heating current at an initial phase of the heating cycle before the heating current causes the heating element to substantially heat up. The cold measurement may be performed at the second time as described herein. The first time and the second time may be both be within the heating cycle, i.e. the same heating cycle. The cold measurement may yield a measured value of the heating current. The measured value may be the measured second value of the heating current as described herein. The method may optionally include determining a performance degradation characteristic, or performance degradation analytic, of the heating element using the measured value of the heating current and the applied voltage.

A performance degradation characteristic, or performance degradation analytic, of the heating element can be understood as a characteristic, or quantity, that represents whether, and more specifically how much, the heating rate of the heating element has changed, or degraded, over time. For example, the heating rate may degrade or deteriorate due to repeated and/or continued use of the heating element, due to the high temperatures generated in the heating element during heating, due to exposure of the heating element to adverse weather conditions such as frost, and the like. The performance degradation characteristic may quantify to which extent the quality of the heating element has decreased due to such factors, which may be known or unknown.

The performance degradation characteristic may be or include a resistance degradation characteristic. The performance degradation characteristic may be or include a deviation between an actual electrical resistance of the heating element and a reference electrical resistance of the heating element. The actual resistance of the heating element may be the resistance of the heating element at an initial phase, or cold phase, of a heating cycle, as described herein. The actual resistance may be determined based on a cold measurement of the heating current. The reference resistance may be a known quantity. The reference resistance may be the resistance which the heating element has by design, before the heating element has been put into operation. The reference resistance may be, for example, a factory defined resistance of the heating element.

The applied voltage for providing the heating current may be a known voltage, or the method may include measuring the applied voltage. The performance degradation characteristic may be determined based on the measured value of the heating current and the applied voltage using Ohm's law. Determining the performance degradation characteristic may include determining a resistance of the heating element using the measured value of the heating current and the applied voltage. Determining the performance degradation characteristic may include determining a deviation between the determined resistance and a reference resistance of the heating element.

The determination of the performance degradation characteristic may be part of the method for determining the temperature of the heating element as described herein. The determination of the performance degradation characteristic is an optional part of the temperature determination method that can be omitted. According to embodiments, the determination of the performance degradation characteristic as described herein may be an independent method in its own right, that is to say, irrespective of whether the method for determining the temperature of the heating element is performed or not.

According to a further embodiment, a system for determining a temperature of a heating element of a wind turbine blade is provided. The system includes a current sensor for measuring, at a first time, a first value of a heating current provided in the heating element. The system includes a controller configured for determining a first temperature of the heating element using the measured first value of the heating current and a known functional dependency between the heating current in the heating element and the temperature of the heating element. The system may be configured to perform any embodiment of the method described herein.

The controller may, for example, be wind turbine controller 202 or controller 230 shown in the figures.

The system may be configured for determining the first temperature of the heating element without determining an electrical resistance or impedance of the heating element.

The controller may be a wind turbine controller or a portion thereof. The controller may be part of a wind turbine. Alternatively, the controller may be a separate controller external to the wind turbine.

The controller may be connected to the current sensor. The controller may be configured for receiving the measured first value of the heating current from the current sensor.

The controller may be configured for storing, reading, receiving, or otherwise acquiring the known functional dependency between the heating current in the heating element and the temperature of the heating element. For example, the known functional dependency may be stored in a memory of the controller, may be read by the controller from a memory external to the controller, may be communicated to the controller via wired or wireless communication, and the like. The controller may be configured for inputting the measured first value into said known functional dependency. The controller may be configured for determining, or deriving, the first temperature from the known functional dependency after inputting the measured first value therein.

The current sensor may be configured for measuring a second value of the heating current at a second time. The controller may be configured for determining the temperature of the heating element using the measured first value of the heating current, the measured second value of the heating current, and the known functional dependency between the heating current in the heating element and the temperature of the heating element. The controller may be configured for inputting the measured first value and the measured second value into said known functional dependency. The controller may be configured for determining, or deriving, the first temperature from the known functional dependency after inputting the measured first value and the measured second value therein. The temperature of the heating element may be determined by the controller using a difference between the measured first value and the measured second value of the heating current.

The current sensor may be part of the wind turbine. As described above, the current sensor may be disposed in the hub of the wind turbine. The current sensor may be a current transducer, for example a current transducer disposed in the hub.

According to a further embodiment, a wind turbine is provided. The wind turbine includes a rotor having a wind turbine blade including a heating element. The wind turbine includes a power supply for supplying a heating current to the heating element. The wind turbine includes a system for determining a temperature of the heating element according to embodiments described herein. The wind turbine may be configured to perform the method according to embodiments described herein.

According to a further embodiment, a computer program product or a non-transitory computer-readable storage medium is provided. The computer program product or non-transitory computer-readable storage medium includes instructions which, when executed by one or more processors of a system, cause the system to determine a first temperature of a heating element using a measured first value of a heating current provided in the heating element and a known functional dependency between the heating current in the heating element and the temperature of the heating element. The computer program product or non-transitory computer-readable storage medium may be configured for carrying out any operation(s) performed by the controller for determining the temperature of the heating element according to the method described herein.

According to a further embodiment, a method for determining a performance degradation characteristic, or performance degradation analytic, of a heating element of a wind turbine blade is provided. The method includes applying a voltage to the heating element to provide a heating current in the heating element for heating the heating element, wherein the heating current is provided during a heating cycle of the heating element. The method includes performing a cold measurement of the heating current at an initial phase of the heating cycle before the heating current causes the heating element to substantially heat up, wherein the cold measurement yields a measured value of the heating current. The method includes determining a performance degradation characteristic of the heating element using the measured value of the heating current and the applied voltage.

The applied voltage may be a known voltage or the method may include measuring the applied voltage.

The performance degradation characteristic may be determined based on the measured value of the heating current and the applied voltage using Ohm's law.

Determining the performance degradation characteristic may include determining a resistance of the heating element using the measured value of the heating current and the applied voltage. Determining the performance degradation characteristic may include determining a deviation between the determined resistance and a reference resistance of the heating element.

According to a further embodiment, a system for determining a performance degradation characteristic of a heating element of a wind turbine blade is provided. The system includes a voltage supply for applying a voltage to the heating element to provide a heating current in the heating element for heating the heating element, wherein the heating current is provided during a heating cycle of the heating element. The system includes a current sensor for performing a cold measurement of the heating current at an initial phase of the heating cycle before the heating current causes the heating element to substantially heat up, wherein the cold measurement yields a measured value of the heating current. The system includes a controller for determining a performance degradation characteristic of the heating element using the measured value of the heating current and the applied voltage.

The aspects described below under items 1 to 15 are also part of the present disclosure:

Item 1. A method of determining a temperature of a heating element (210) of a wind turbine blade (200), comprising:
heating the heating element by providing a heating current in the heating element;
measuring a first value (I₁) of the heating current at a first time;
determining a first temperature (T₁) of the heating element using:
   the measured first value of the heating current; and
   a known functional dependency (410) between the heating current in the heating element and the temperature of the heating element.

Item 2. The method of item 1, wherein the first temperature of the heating element is determined without determining an electrical resistance of the heating element.

Item 3. The method of item 1 or 2, wherein the known functional dependency is, at least approximately, a linear dependency between the heating current in the heating element and the temperature of the heating element.

Item 4. The method of any of the preceding items, wherein the known functional dependency is obtained from a testing phase, wherein the testing phase includes:
heating a test heating element (210′) for a wind turbine blade by providing a test heating current in the test heating element;
measuring a plurality of values of the test heating current and corresponding values of the temperature of the test heating element at different times; and
determining a functional dependency (410) between the test heating current in the test heating element and the temperature of the test heating element based on the plurality of measured values of the test heating current and the corresponding measured values of the temperature of the test heating element.

Item 5. The method of any of the preceding items, wherein the wind turbine blade is part of wind turbine (100), the wind turbine having a hub (110), and wherein the first value of the heating current is measured by a current transducer (710) disposed in the hub.

Item 6. The method of any of the preceding items, further comprising:
measuring a second value of the heating current at a second time,
wherein the first temperature of the heating element is determined using the measured first value of the heating current, the measured second value of the heating current, and the known functional dependency between the heating current in the heating element and the temperature of the heating element.

Item 7. The method of item 6, wherein the first temperature of the heating element is determined using a difference between the measured first value and the measured second value of the heating current.

Item 8. The method of item 6 or 7, wherein the measurement of the second value of the heating current is a cold measurement performed at an initial phase of a heating cycle before the heating current causes the heating element to substantially heat up.

Item 9. The method of any of the preceding items, further comprising:
applying a voltage to the heating element to provide the heating current in the heating element, wherein the heating current is provided during a heating cycle of the heating element;
performing a cold measurement of the heating current at a second time in an initial phase of the heating cycle before the heating current causes the heating element to substantially heat up, wherein the cold measurement yields a measured second value (Iₘᵢₙ) of the heating current; and
determining a performance degradation characteristic of the heating element using the measured second value of the heating current and the applied voltage.

Item 10. The method of any of the preceding items, wherein the heating element is configured for de-icing the wind turbine blade.

Item 11. The method of any of the preceding items, wherein the heating element is a heating mat of the wind turbine blade, particularly a carbon heating mat.

Item 12. A system for determining a temperature of a heating element (210) of a wind turbine blade (200), comprising:
a current sensor (710) for measuring a first value of a heating current in the heating element at a first time; and
a controller (230, 202) configured for determining a first temperature of the heating element using:
   the measured first value of the heating current; and
   a known functional dependency (410) between the heating current in the heating element and the temperature of the heating element.

Item 13. A wind turbine (100), comprising:
a rotor having a wind turbine blade (200) comprising a heating element (210);
a power supply (220) for supplying a heating current to the heating element;
a system for determining a temperature of the heating element according to items 12.

Item 14. A computer program product or a non-transitory computer-readable storage medium comprising instructions which, when executed by one or more processors of a system, cause the system to determine a first temperature of a heating element (210) using a measured first value of a heating current being provided in the heating element and a known functional dependency between the heating current in the heating element and the temperature of the heating element.

Item 15. A method for determining a performance degradation characteristic of a heating element (210) of a wind turbine blade (200), comprising:
applying a voltage to the heating element to provide a heating current in the heating element for heating the heating element, wherein the heating current is provided during a heating cycle of the heating element;
performing a cold measurement of the heating current at an initial phase of the heating cycle before the heating current causes the heating element to substantially heat up, wherein the cold measurement yields a measured value of the heating current; and
determining a performance degradation characteristic of the heating element using the measured value of the heating current and the applied voltage.

As used herein, the term “processor” refers not only to integrated circuits referred to in the art as being included in a computer, but also refers to a controller (such as wind turbine controller 202 or controller 230 described herein), a microcontroller, a microcomputer, a programmable logic controller (PLC), an application specific integrated circuit, and other programmable circuits. The processor may also be configured to compute advanced control algorithms and communicate to a variety of Ethernet or serial-based protocols (Modbus, OPC, CAN, etc.). Additionally, the processor may have access to memory device(s) that may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magnetooptical disk (MOD), a digital versatile disc (DVD) and/or other suitable memory elements. Such memory device(s) may generally be configured to store suitable computer-readable instructions that, when implemented by the processor(s), configure the controller to perform the various functions as described herein.

Exemplary embodiments are described above in detail. The systems and methods are not limited to the specific embodiments described herein, but rather, components of the systems and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

Embodiments of the present invention have been described above with reference to methods, apparatuses (i.e., systems) and computer program products. It will be understood that each operation of a method, and combinations of operations, respectively, can be implemented by various means including computer program instructions. These computer program instructions may be loaded onto a general-purpose computer, special purpose computer, or other programmable data processing apparatus to produce a machine, such that the instructions which execute on the computer or other programmable data processing apparatus create a means for implementing the operations of the methods.

These computer program instructions may also be stored in a non-transitory computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the operations included in the methods.

Accordingly, operations of the methods support combinations of means for performing the specified functions, combinations of steps for performing the specified functions and program instruction means for performing the specified functions. It will also be understood that each operation of the methods, and combinations of operations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. For example, the control system of the wind farm may be provided by one centralized controller or a plurality of interconnected controllers. Such other examples are intended to be within the scope of the claims if they have structural elements that do not differ from the literal language of the claims, or if they include equivalent structural elements with insubstantial differences from the literal language of the claims.

### REFERENCE NUMBERS

wind direction 28
axis of rotation 30
yaw axis 38
wind turbine 100
nacelle 102
tower 104
yaw system 105
rotor 106
mast 107
rotor blade 108
pitch system 109
hub 110
wind turbine blade 200
wind turbine controller 202
heating element 210
power supply 220
power cables 222
controller 230
proximal end 250
vertical axis 402
horizontal axis 404
functional dependency 410
temperature sensor 502
current sensor 504
data point 602
current sensor 710
test heating element 210′
power supply 220′

1-15. (canceled)

16. A method of determining a temperature of a heating element of a wind turbine blade, the method comprising:
heating the heating element by providing a heating current in the heating element;
measuring a first value of the heating current at a first time;
determining a first temperature of the heating element; and
measuring a second value of the heating current at a second time,
wherein the first temperature of the heating element is determined using the measured first value of the heating current, the measured second value of the heating current, and a known functional dependency between the heating current in the heating element and the temperature of the heating element.

17. The method of claim 16, further comprising determining the first temperature of the heating element without determining an electrical resistance of the heating element.

18. The method of claim 16, wherein the known functional dependency is, at least approximately, a linear dependency between the heating current in the heating element and the temperature of the heating element.

19. The method of claim 16, wherein the known functional dependency is obtained from a testing phase, wherein the testing phase comprises:
heating a test heating element for the wind turbine blade by providing a test heating current in the test heating element;
measuring a plurality of values of the test heating current and corresponding values of the temperature of the test heating element at different times; and
determining a functional dependency between the test heating current in the test heating element and the temperature of the test heating element based on the plurality of measured values of the test heating current and the corresponding measured values of the temperature of the test heating element.

20. The method of claim 16, wherein the wind turbine blade is part of wind turbine having a hub, and wherein the first value of the heating current is measured by a current transducer disposed in the hub.

21. The method of claim 16, wherein the first temperature of the heating element is determined using a difference between the measured first value and the measured second value of the heating current.

22. The method of claim 16, wherein the measurement of the second value of the heating current is a cold measurement performed at an initial phase of a heating cycle before the heating current causes the heating element to substantially heat up.

23. The method of claim 16, further comprising:
applying a voltage to the heating element to provide the heating current in the heating element, wherein the heating current is provided during a heating cycle of the heating element; and
performing a cold measurement of the heating current at a second time in an initial phase of the heating cycle before the heating current causes the heating element to substantially heat up, wherein the cold measurement yields a measured second value of the heating current.

24. The method of claim 23, further comprising determining a performance degradation characteristic of the heating element using the measured second value of the heating current and the applied voltage.

25. The method of claim 16, wherein the heating element is configured for de-icing the wind turbine blade.

26. The method of claim 16, wherein the heating element is a heating mat of the wind turbine blade.

27. The method of claim 66, wherein the heating mat comprises a carbon heating mat.

28. A system for determining a temperature of a heating element of a wind turbine blade, the system comprising:
a current sensor for measuring a first value of a heating current in the heating element at a first time and for measuring a second value of the heating current at a second time; and
a controller configured for determining a first temperature of the heating element using:
the measured first value of the heating current;
the measured second value of the heating current; and
a known functional dependency between the heating current in the heating element and the temperature of the heating element.

29. The system of claim 28, further comprising a power supply for supplying the heating current to the heating element.

30. A method for determining a performance degradation characteristic of a heating element of a wind turbine blade, the method comprising:
applying a voltage to the heating element to provide a heating current in the heating element for heating the heating element, wherein the heating current is provided during a heating cycle of the heating element;
performing a cold measurement of the heating current at an initial phase of the heating cycle before the heating current causes the heating element to substantially heat up, wherein the cold measurement yields a measured value of the heating current; and
determining a performance degradation characteristic of the heating element using the measured value of the heating current and the applied voltage.
